(19) United States
(12) Patent Application Publication
(10) Pub. No.: US 2007/0050320 A1
(43) Pub. Date: Mar. 1, 2007

(54) Method and system for mapping context name space binding lookups

(76) Inventor: Scott R. Carrier, Apex, NC (US)

Correspondence Address: IBM CORP. (RALEIGH SOFTWARE GROUP);c/o Rudolf O Siegesmund Gordon & Rees, LLP, 2100 Ross Avenue, Suite 2600, DALLAS, TX, 75201, US

(21) Appl. No.: 11/211,907

(22) Filed: Aug. 25, 2005

(51) Int. Cl. G06F 17/30

(52) U.S. Cl. 707/1

(57) ABSTRACT

The Binding Mismatch Mapper (BMM) responds to reference lookup errors by searching for the mismatched binding and mapping the reference in an XML file. The Binding Mismatch Mapper (BMM) comprises a URL cache generator (UCG), a lookup error monitor (LEM), a search component (SC), and a mapping component (MC). The UCG stores all URLs accessed by applications on the server in an XML file. The LEM monitors the naming interface for reference lookup errors. When the LEM detects a lookup error, the LEM starts the SC. The SC first searches for previously mapped mismatches for the reference. If the reference is not already mapped, the SC performs a lookup on other contexts listed in the URL cache file. When the SC finds the reference, the MC maps the reference to the proper name space in the mapping cache file. The mapping cache file is in an XML format so that other applications can easily use the data to correct the name space bindings. An optional Binding Adaptor (BA) corrects the naming mismatch in the application framework using the mapping cache file.

### FIELD OF THE INVENTION

The present invention relates generally to one computer accessing another computer's memory. More particularly, the present invention relates to correcting reference lookup errors by searching for a mismatched binding and mapping the reference in an XML file.

### BACKGROUND OF THE INVENTION

Objects, such as applications or files, are located in storage on a computer. Objects are assigned a name for identification. Each computer uses a protocol for naming objects located in storage. The naming and directory application on a computer is called a “naming interface.” The hierarchy of names for the objects in the storage of a server is called a name space. There are multiple standards used for naming objects in a name space. Java Naming and Directory Interface (JNDI) and Common Object Request Broker Architecture (CORBA) are known standards for naming objects in a name space. JNDI and CORBA are commonly used to name objects in a server environment.

Applications in a server environment do not always run as a single program in one location. Applications are generally made up of multiple objects, called “contexts,” which may be distributed in storage across multiple servers. The main context of an application uses the file system's lookup command to locate and run other contexts as needed. The lookup command is often performed with a Hypertext Transfer Protocol (HTTP) request, using Uniform Resource Locators (URLs). The URL of a context will specify the physical or logical location of the requested context. In addition to contexts, other objects used by an application, such as data files, may be located on different name spaces.

Name space bindings are used to reference objects from one name space to another. A name space binding is essentially a path name, stored on a first server which allows applications to locate an object on a second server. Known methods to bind objects between multiple name spaces include using a federated name space or an indirect lookup. US patent application US 2003/0074484 describes a method of using an indirect lookup for binding objects in a CORBA name space.

Name space bindings must be updated when the name of an object changes, or else there will be a mismatch. If a user or application performs a lookup using the old name to locate an object, the naming interface will return a “reference lookup error.” Manually creating a lookup table to map old name space bindings to a new object name and federating name space bindings are known ways to correct name space binding mismatches. System administrators must complete manual lookup table updates or create federated name space bindings (federating name spaces involves binding contexts from one name space into another name space) before mismatch errors disrupt applications.

A need exists for a method to identify and map name space binding mismatches at runtime whenever name space bindings are altered in an application server environment.

### SUMMARY OF THE INVENTION

The Binding Mismatch Mapper (BMM) meets the need mentioned above by responding to reference lookup errors at runtime, searching for the mismatched binding and automatically mapping the reference in an Extensible Markup Language (XML) file.

The BMM runs on a server and comprises a URL cache generator (UCG), a lookup error monitor (LEM), a search component (SC), and a mapping component (MC). The UCG stores all URLs accessed by applications on the server. The URLs are stored in a URL cache file in an XML format. The LEM monitors the server's naming interface for reference lookup errors. When the LEM detects a reference lookup error, it starts the SC. The SC searches for the mismatched binding in a mapping cache file. If the mismatched binding is not already listed in the mapping cache file, the SC performs a reference lookup on other contexts listed in the URL cache file. If the SC finds the reference, the MC maps the reference to the proper name space in the mapping cache file. If the SC fails to find the reference, an error message is returned. The MC stores the mapped reference to the mapping cache file in an XML format because XML files store data in a format that can easily be read by other applications, such as a Binding Adaptor (BA). The BA is an application that reads the data from the mapping cache file and corrects the mismatch in the application framework. The BA, for example, can automatically bind the reference to the correct name space using a federated name space or an indirect lookup.

### BRIEF DESCRIPTION OF DRAWINGS

The novel features believed characteristic of the invention are set forth in the appended claims. The invention itself, however, as well as a preferred mode of use, further objectives and advantages thereof, will be understood best by references to the following detailed description of an illustrative embodiment when read in conjunction with the accompanying drawings, wherein:

FIG. 1 describes a server cluster where the invention would be used.

FIG. 2 describes programs and files in a storage on a server.

FIG. 3 describes the components of the BMM.

FIG. 4 is a flowchart showing the steps taken by the UCG.

FIG. 5 is a flowchart showing the steps taken by the LEM.

FIG. 6 is a flowchart showing the steps taken by the SC.

FIG. 7 is a flowchart showing the steps taken by the MC.

FIG. 8 is a flowchart showing the steps taken by the BA.

FIG. 9 describes one embodiment of the invention.

### DETAILED DESCRIPTION OF THE PREFERRED EMBODIMENT

The principles of the present invention are applicable to a variety of computer hardware and software configurations. The term “computer hardware” or “hardware,” as used herein, refers to any machine or apparatus that is capable of accepting, performing login operations on, storing, or displaying data, and includes without limitation processors and memory; the term “computer software” or “software,” refers to any set of instructions operable to cause computer hardware to perform an operation. The term “computer,” as used herein, includes without limitation any useful combination of hardware and software, and a “computer program” or “program” includes without limitation any software operable to cause computer hardware to accept, perform logic operations on, store or display data. A computer program may, and often is, comprised of a plurality of smaller programming units, including without limitation subroutines, modules, functions, methods and procedures. Thus, the functions of the present invention may be distributed among a plurality of computers and computer programs. The invention is described best, though, as a single computer program that configures and enables one or more general purpose computers to implement the novel aspects of the invention. For illustrative purposes, the inventive computer program will be referred to as the “Binding Mismatch Mapper (BMM).”

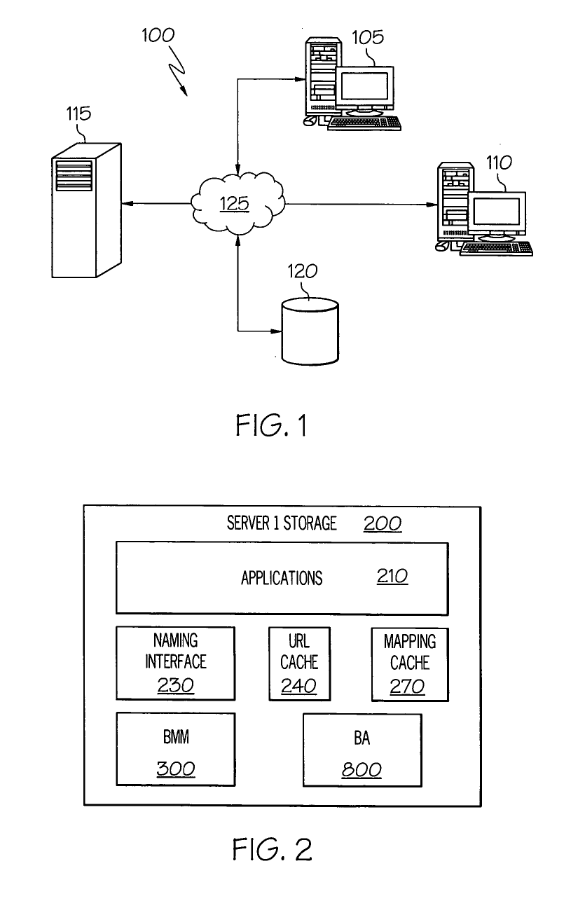

Additionally, the BMM is described below with references to an exemplary network of hardware devices, as depicted in FIG. 1. The term “network,” as used herein, comprises any number of hardware devices coupled to and in communication with each other through a communications medium, such as the internet. The term “communications medium,” as used herein, includes without limitation any physical, optical, electromagnetic, or other medium through which hardware or software can transmit data. For descriptive purposes only, exemplary network 100 has only a limited number of nodes, including first client computer 105, second client computer 110, server computer 115, and storage 120. First network connection 125 comprises all hardware, software and communications media necessary to enable communication between network nodes 105-120. Unless otherwise indicated below, all network nodes use publicly available protocols or messaging services to communicate with each other through network connection 125.

BMM 300 typically is located in a storage, represented schematically as storage 200 in FIG. 2. The term “storage,” as used herein, includes without limitation any volatile or persistent medium, such as an electrical circuit, magnetic disk, or optical disk, in which a computer can store data or software for any duration. A single storage may encompass and be distributed across a plurality of media. Thus, FIG. 2 is included merely as a descriptive expedient and does not necessarily reflect any particular physical embodiment of storage 200.

Each server runs a plurality of applications 210 as shown in FIG. 2. The storage of each server has a naming interface 230, such as JNDI, which is capable of performing a lookup function. Storage 200 has a URL cache file 240 and a mapping cache file 270. Storage 200 also contains BMM 300 and a binding adaptor (BA) 800.

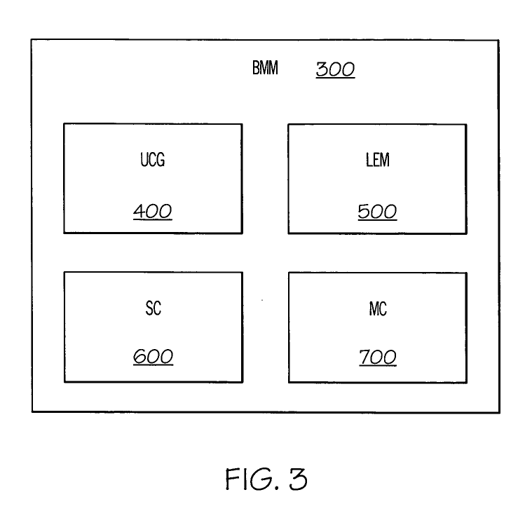

BMM 300, as shown in FIG. 3, comprises a URL cache generator (UCG) 400, a lookup error monitor (LEM) 500, a search component (SC) 600, and a mapping component (MC) 700.

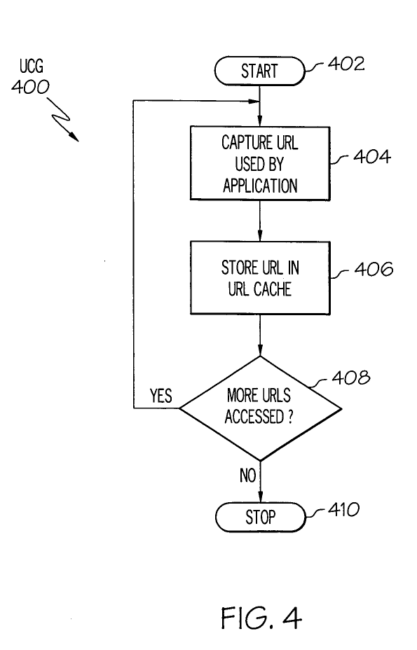

UCG 400 stores a history file of all URLs accessed by applications on the server as shown in FIG. 4. UCG 400 starts (402) and captures all URLs accessed by applications on the server (404). UCG 400 stores the URLs in the URL cache 240 (406). URL cache 240 is preferably an XML file because XML files list information in a format that can easily be accessed by other programs. UCG 400 repeats the process of capturing and storing URLs if another URL is accessed (408) otherwise UCG 400 stops (410).

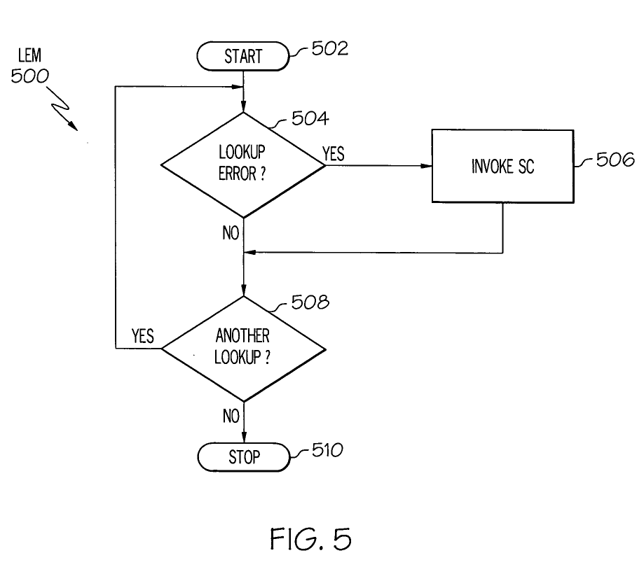

In FIG. 5, LEM 500 starts (502) and monitors naming interface 230, such as a JNDI, for reference lookup errors. When LEM 500 detects a lookup error (504), LEM 500 invokes SC 600 (506). LEM 500 continues monitoring naming interface 230 as long as lookups are performed (508), otherwise LEM 500 stops (510).

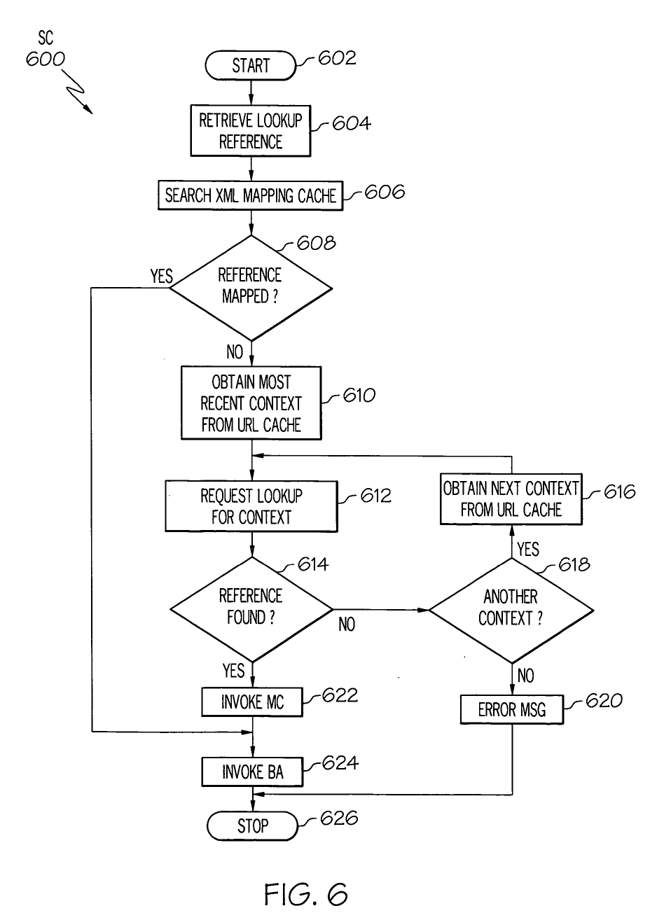

When LEM 500 detects a reference lookup error, SC 600 searches for the mismatched binding as shown in FIG. 6. SC 600 starts (602) and retrieves the failed lookup reference (604). SC 600 first searches for the mismatched binding in the mapping cache file (606). If the mismatched binding is already mapped (608), then SC 600 invokes BA 800 (624) then stops (626). If the mismatched binding is not mapped (608), SC 600 opens URL cache 240 and obtains the most recent URL (610). The most recent URL may be obtained by searching in descending order. Alternatively, context nodes could be searched synchronously using a multi-threaded search procedure. Moreover, the type of search employed could be configurable by the end user. Next, SC 600 performs a lookup of the reference using the context in the URL (612). If the reference does not match the context in the URL (614), SC 600 determines if there is another URL in URL cache 240 (618). If there is another URL, SC 600 obtains this URL from URL cache 240 (616). The SC repeats the reference lookup (612) using each context listed in the URL cache until the reference is found or the URL cache has been fully searched. Once the reference is found (614), SC 600 invokes MC 700 (622). After MC 700 maps the mismatch, BA 800 is invoked to correct the binding mismatch (624) and SC 600 stops (626). If a lookup is performed for all URLs in URL cache 240 without locating the reference (618), an error message is returned (620) and SC 600 stops (626)

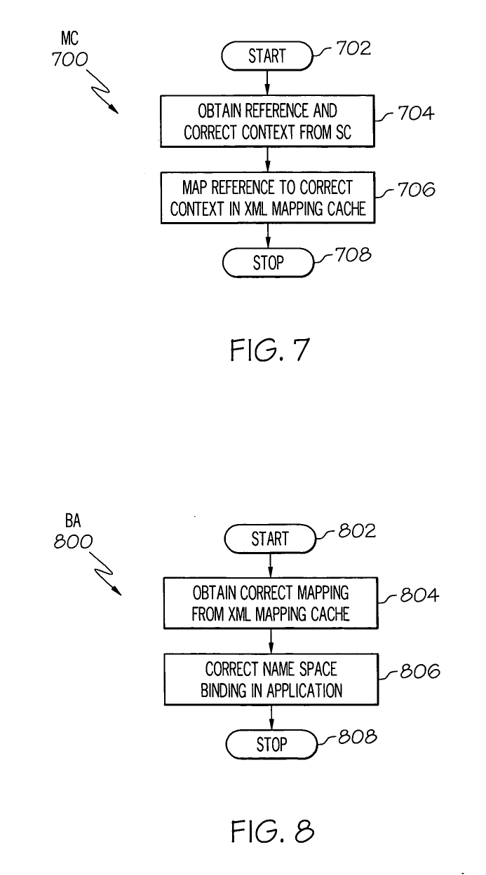

If SC 600 finds the reference, MC 700 maps the reference to the proper name space as shown in FIG. 7. MC 700 starts (702) and obtains the reference and the correct context from SC 600 (704). MC 700 writes the reference and correct context to mapping cache file 270 (706) then stops (708). Like URL cache 240, mapping cache 270 is an XML file. The mapping information is stored in a format that can easily be accessed by other programs to correct the name bindings.

Optional adapters may be plugged in at the end of the process to correct the mapping at runtime at the application server using lookup bindings. Binding a name to an object is known in the art. Adaptors may use, for example, federated name space bindings or indirect lookup tables to automatically correct the binding mismatch. A further option may be to invoke an adapter interface call at the end of the mapping correction procedure so that the end user can run additional custom routines during the corrective mapping process.

FIG. 8 shows an exemplary plug-in, Binding Adaptor (BA) 800, for correcting the mismatch in the application framework. BA 800 starts (802) and obtains the XML formatted information in mapping cache file 270 (804). BA 800 corrects the name space bindings in the application framework (806) then stops (808).

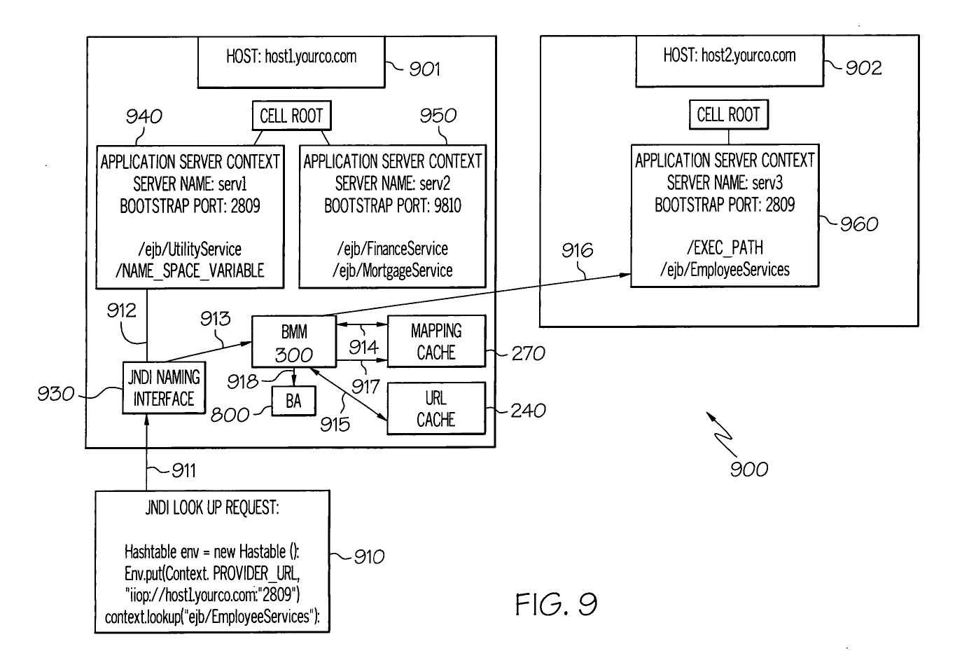

A preferred embodiment of the invention is described in FIG. 9. A lookup request is initiated 910 (911). JNDI naming interface 930 does not locate the reference “ejb/EmployeeServices” at the listed context “host1.yourco.com:2809” 940 and returns an error (912). The error is detected by BMM 300 (913). BMM 300 performs a search for the mismatched reference as described above in FIG. 7. First BMM 300 searches mapping cache 270 to determine if the mismatch has already been mapped (914). When BMM 300 determines the reference has not been mapped, BMM 300 accesses URL cache 240 for a list of other contexts (915). URL cache 240 has a listing for “host2.yourco.com”. BMM 300 performs a lookup for the reference “ejb/EmployeeServices” at the context “host2.yourco.com” 960 (916). The lookup to “host2.yourco.com” was successful, so BMM 300 maps the reference “ejb/EmployeeServices” to the context “host2.yourco.com” in mapping cache 270 (917). BMM 300 invokes BA 800 to correct the name space bindings in the application (918).

A preferred form of the invention has been shown in the drawings and described above, but variations in the preferred form will be apparent to those skilled in the art. The preceding description is for illustrative purposes only, and the invention should not be construed as limited to the specific form shown and described. The scope of the invention should be limited only by the language of the following claims.

What is claimed is:

1. A programmable apparatus for automatically mapping mismatched name space binding references comprising:
a computer having a processor, a memory, a plurality of applications and a naming interface;
a binding mismatch mapping program installed on said computer;
wherein, the binding mismatch mapping program detects a lookup error for a reference;
wherein, responsive to detecting the lookup error, the binding mismatch mapping program searches for the reference in a plurality of other contexts; and
wherein, responsive to locating the reference in the plurality of other contexts, the binding mismatch mapping program maps the reference to the correct context in an XML file.

2. The programmable apparatus of claim 1 wherein the binding mismatch mapping program further comprises:
a uniform resource locator cache generator that stores a history file of all uniform resource locators accessed on a server cluster in an XML file.

3. The programmable apparatus of claim 2 wherein the binding mismatch mapping program further comprises:
a lookup error monitor that monitors a naming interface for a reference lookup error, and responsive to detecting the reference lookup error, invokes a search component to search for the mismatched binding.

4. The programmable apparatus of claim 3 wherein the search component further comprises:
performing a lookup on other contexts from the uniform resource locator cache file, and responsive to finding the reference, invoking a mapping component.

5. The programmable apparatus of claim 4 wherein the mapping component further comprises:
mapping the reference to the proper name space in the mapping cache file.

6. The programmable apparatus of claim 5 further comprising:
binding adaptors that correct a mismatch in an application framework using the mapping cache file.

7. A computer program product for automatically mapping mismatched name space binding references comprising:
a computer readable medium containing instructions to cause a computer, to detect a lookup error for a reference, and responsive to detecting the lookup error, to search for the reference in other contexts, and to map the reference to the correct context in an XML file.

8. The computer program product of claim 7 further comprising:
a uniform resource locator cache generator containing instructions to cause the computer to store a history file of all uniform resource locators accessed on a server cluster in an XML file.

9. The computer program product of claim 7 further comprising:
a lookup error monitor containing instructions to cause the computer to monitor a naming interface for reference lookup errors, and responsive to detecting a lookup error, invoke a search component to search for a mismatched binding.

10. The computer program product of claim 9 further comprising:
a search component containing instructions to cause the computer to perform a lookup on other contexts for the reference from a uniform resource locator cache file, and responsive to finding the reference, invoking a mapping component.

11. The computer program product of claim 10 further comprising:
a mapping component containing instructions to cause the computer to map the reference to a proper name space in a mapping cache file.

12. The computer program product of claim 11 further comprising:
a binding adaptor to correct a mismatch in an application framework using the mapping cache file.

13. A method for automatically mapping mismatched name space binding references comprising:
detecting a lookup error for a reference;
searching a mapping cache for the reference; and
mapping the reference to the correct context in the mapping cache when the correct context has been found.

14. The method for automatically mapping mismatched name space binding references of claim 13 further comprising:
responsive to determining that the reference has not been previously mapped, performing a lookup for the reference on other contexts listed in a URL cache.

15. The method for automatically mapping mismatched name space binding references of claim 14 further comprising:
storing a history file of all uniform resource locators accessed on a server cluster in an XML file.

16. The method for automatically mapping mismatched name space binding references of claim 15 further comprising:
monitoring a naming interface for reference lookup errors; and
responsive to detecting a lookup error, invoking a search component to search for a mismatched binding.

17. The method for automatically mapping mismatched name space binding references of claim 16 further comprising:
performing a lookup on other contexts for the reference from a uniform resource locator cache file.

18. The method for automatically mapping mismatched name space binding references of claim 17 further comprising:
responsive to finding the reference, mapping the reference to a proper name space in a mapping cache file.

19. The method for automatically mapping mismatched name space binding references computer program product of claim 18 further comprising:
correcting a mismatch in an application framework using the mapping cache file.
